(19) United States
(12) Patent Application Publication
(10) Pub. No.: US 2018/0123180 A1
(43) Pub. Date: May 3, 2018

(54) ELECTROCHEMICAL DEVICE FOR STORING ELECTRICAL POWER

(71) Applicant: JOMI LEMAN, Fessy (FR)

(72) Inventor: Michel JEHAN, Fessy (FR)

(73) Assignee: JOMI LEMAN, Fessy (FR)

(21) Appl. No.: 15/569,664

(22) PCT Filed: Jun. 30, 2016
(86) PCT No.: PCT/FR2016/051641

§ 371 Date: Oct. 26, 2017

(30) Foreign Application Priority Data
Jun. 30, 2015 (FR) 1556149

(51) Int. Cl. H01M 10/42; H01M 4/56; H01M 4/38; H01M 10/44

(52) U.S. Cl. CPC H01M 10/4214; H01M 4/56; H01M 2004/029; H01M 10/44; H01M 4/387

(57) ABSTRACT

A reactor provided with a side wall, a top wall, a bottom wall, and electrolyte inlet, and an electrolyte outlet, a plurality of electrodes Eₓ with x an integer between 1 and n, located in the reactor, the electrodes being in the form of cones and frusta, arranged alternately and fitted in such a way that the tapered part of each electrode is directed towards the top wall or the bottom wall of the reactor, the frusta coming into contact with the side wall, the apexes of the cones defining an axis passing through the open areas of the frusta.

### BACKGROUND OF THE INVENTION

The invention relates to an electrochemical device for storing electric power and to a method for storing electric power.

### STATE OF THE ART

There are many issues at stake in the field of bulk storage of electric power. It is in fact essential to have storage units able to operate over a very wide power and capacity range while at the same time privileging the aspects of presenting small volumes.

A promising manner for storing such power is by means of an electrochemical process. Nowadays, the most efficient and safest electrochemical technology is that of electrolysis of non-ferrous metals in an aqueous medium, and more particularly electrolysis of metals which have a high energy content such as zinc or manganese. Furthermore, the technology is simple and inexpensive: it would therefore be advantageous to be able to make such an electrolysis operate in reversible manner.

Patent application WO 2011/015723 describes a method for simultaneous cogeneration of electric power and hydrogen by totally electrochemical means. The method comprises a phase of electricity storage by electrolysis of a solution of an electrolyzable metal and formation of an electrolyzable metal-hydrogen battery, and a phase of electricity recovery and hydrogen generation by operation of said battery

However, in such devices, the volumes of the reactors are very large in order to be able to provide a large quantity of electric power.

Furthermore, for high power applications, the metal deposits are often inhomogeneous, which impairs the electrochemical performances of the devices, and may even cause short-circuiting of the electrodes by formation of metallic dendrites.

### OBJECT OF THE INVENTION

The object of the invention is to remedy the shortcomings of the prior art, and in particular to propose a device enabling a large quantity of electric power to be stored

This object tends to be achieved by an electrochemical device for storing electric power comprising a reactor provided with a side wall, a top wall, a bottom wall, an electrolyte inlet, an electrolyte outlet, and a plurality of electrodes Ex with x an integer between 1 and n, located in the reactor, the electrodes being in the form of cones and frusta arranged alternately and fitted in such a way that the tapered part of each electrode is directed towards the top wall or the bottom wall of the reactor, the frusta coming into contact with the side wall of the reactor, the apexes of the cones defining an axis passing through the open areas of the frusta.

This object also tends to be achieved by a method for storing electric power comprising the following successive steps:
providing the above-mentioned electrochemical device for storing electric power,
performing inlet of an electrolyte to the electrochemical device, the electrolyte containing metal ions,
electrically connecting the first electrode to the negative terminal of an electric power supply and the second electrode to the positive terminal of an electric power supply,
providing electric power to reduce the metal ions on the electrodes of the electrochemical device so as to form an electrolyzable metal battery.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents a schematic view of a reactor of an electrochemical device according to an embodiment of the invention, in cross-section,

FIG. 2 schematically represents an additional electrode of an electrochemical device according to the invention, in cross-section.

### DESCRIPTION OF A PREFERENTIAL EMBODIMENT OF THE INVENTION

The invention relates to an electrochemical device for storing electric power in direct and reversible manner.

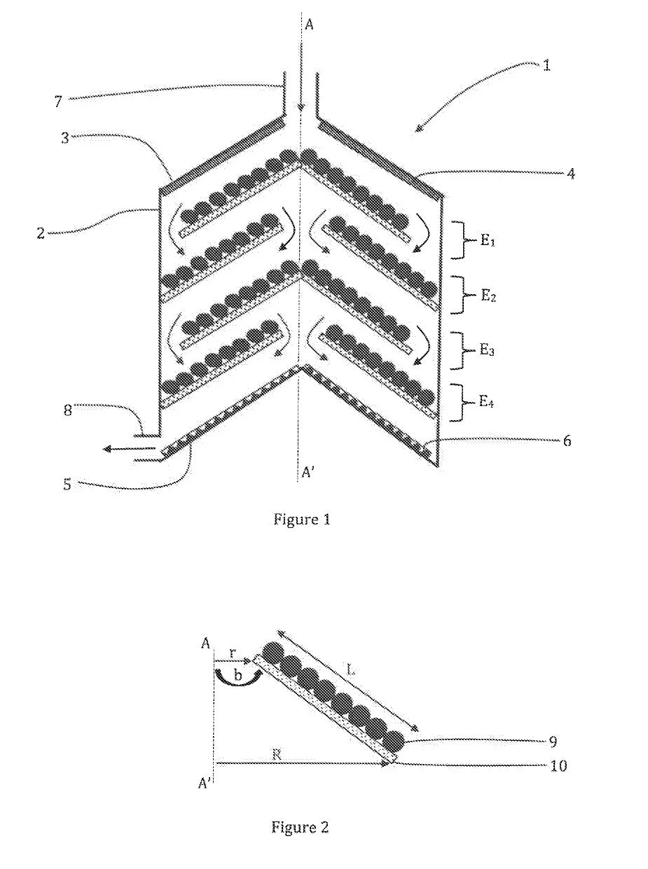

As represented in FIG. 1, the electrochemical device for storing electric power comprises:
a reactor 1 provided with:
   a side wall 2,
   a top wall 3,
   a bottom wall 5,
   an electrolyte inlet 7,
   an electrolyte outlet 8,
a plurality of electrodes Ex with x an integer between 1 and n, located in the reactor, the electrodes being in the form of cones and frusta, arranged alternately and fitted in such a way that the tapered part of each electrode is directed towards the top wall 3 or the bottom wall 5 of the reactor 1, the frusta coming into contact with the side wall 2, the apexes of the cones defining an axis passing through the open areas of the frusta.

The reactor 1 is preferentially a closed reactor in which the electrolyte flows. The reactor 1 is for example a vessel. The side wall 2 is preferentially circular.

The reactor 1 is closed at its top part by a top wall 3 also called cover. The reactor is closed at its bottom part by a bottom wall also called base. The bottom wall 5 and top wall 3 are preferentially of conical shape. The apex of the cone of the top wall 3 and the apex of the cone of the bottom wall 5 define an axis AA′.

What is meant by conical shape is that these walls present a conical surface: their surface is defined by a straight line, or a substantially straight curve, passing through a fixed point, or apex, and a variable point forming a closed flat curve.

The closed section preferentially has a cylindrical or ovoid shape.

The cone is advantageously a cone of revolution and the side wall 2 is a cylinder, the closed section of the bottom wall 5 and top wall 3 forming a circle commensurate with the dimension of the side wall 2.

Advantageously, the top wall 3 is configured to form a first main electrode 4.

According to a first embodiment, the top wall 3 forms the first electrode 4.

According to another embodiment, the top wall 3 acts as mechanical support for the first electrode 4. The first electrode 4 is advantageously supported by the reactor cover. The device is rugged and simple to implement.

The first electrode 4 can be the main anode or the main cathode of the electrochemical device.

In a preferential operating mode, the first electrode 4 forms the main cathode of the electrochemical device.

The first electrode 4 is then connected to the negative terminal of a DC electric power supply.

The cover is advantageously electrically conductive. It is electrically connected to the negative terminal of the DC electric power supply to bias the first electrode which bathes in the electrolyte.

The first electrode 4, designed to be in contact with the electrolyte, can be covered by a coating to enhance the electrochemical reactions and the resistance to chemical and gas attacks.

The first electrode 4 is advantageously made from a material that is not attackable by oxygen in an acid medium. It is for example covered with titanium nitride on its surface, or can be made from steel coated with an electrically conductive ceramic. This conductive ceramic is non oxide.

Preferentially, the first electrode 4 is made from stainless steel.

The bottom wall 5 is configured to form a second main electrode 6.

According to a particular embodiment, the bottom wall 5 forms the second electrode 6.

According to another embodiment, the bottom wall 5 acts as mechanical support for the second electrode 6.

The second electrode is for example made from lead-covered stainless steel.

Preferentially, the second electrode is an anode, which forms the main anode of the electrochemical device.

The bottom wall of the reactor 1 is electrically conductive and is biased to the potential of the positive terminal of the external power supply.

The electrodes Eₓ are arranged between the bottom wall 5 and top wall 3. The electrodes Eₓ are also called additional electrodes.

Electrode E₁ is the additional electrode closest to the first electrode 4. It forms the proximal electrode with respect to the first electrode 4.

Electrode Eₙ is the additional electrode farthest away from the first electrode 4.

It forms the distal electrode with respect to the first electrode 4.

FIG. 1 represents for example a reactor comprising four additional electrodes E₁, E₂, E₃, and E₄. The distal electrode is electrode E₄.

The number of electrodes Eₓ depends on the required electric power.

As represented in FIG. 1, the additional electrodes Eₓ are advantageously in the form of a full cone or of a frustum. The apexes of the conical electrodes and the openings of the electrodes in the form of frusta are aligned along the axis AA′. The apexes and openings of the cones are advantageously all oriented in the same direction.

Preferentially, the apexes and openings are oriented in the direction of the top wall 3, the tapered shape of the cones or of the frusta being arranged in the direction of the bottom wall 5.

In a particular embodiment, the electrodes Ex with x an odd integer are in the form of a full cone and the electrodes Ex with x an even integer are in the form of a frustum.

The electrodes Eₓ with x an odd integer are separated from the side wall 2 of the reactor 1 by a space.

The electrodes Eₓ with x an even integer are in contact with the side wall 2 of the reactor 1. The frustum shape of these electrodes enables the fluid to flow at the apex of the cone.

This embodiment is particularly efficient and compact. However, a reverse configuration is also possible.

According to a preferential embodiment, the electrolyte inlet 7 of the reactor is located in the top wall 3 at the apex of the cone forming the first electrode E₁.

The electrolyte is for example input through the cover, into the reactor, by a volumetric pump, thereby enabling its flowrate and pressure to be controlled.

The electrolyte outlet 8 is located in the bottom part of the reactor 1, between the electrode Eₙ and the bottom wall 5 of the reactor.

The electrolyte outlet 8 can be formed by one or more apertures located in the base of the reactor 1.

As a variant, the electrolyte inlet 7 and electrolyte outlet 8 can be reversed.

A flow path of the electrolyte is thus formed (represented schematically by the arrows in FIG. 1), the path going from the electrolyte inlet 7 to the electrolyte outlet 8, passing alternately between the electrodes Eₓ with x an odd integer and the side wall of the reactor and in the openings arranged at the apex of the frusta of the electrodes Eₓ with x an even integer.

In this embodiment, the flow of the electrolyte is natural and gravitational.

This architecture enables an excellent circulation of the electrolyte fluxes to be obtained, the flux being permanently renewed in front of each electrode.

Such a totally symmetrical geometry makes it possible to deliver an apposite flow of the electric currents from one electrode to the other and enables leakage currents to be eliminated.

However, as a variant, non-symmetrical architectures are possible, but they are however less efficient.

Control of the flow of electric currents, associated with a reduction of turbulences, results in a better homogeneity of the metal deposits.

Advantageously, heat losses are reduced and well distributed.

The electrochemical potential of the electrodes Eₓ is said to be floating, i.e. the total potential difference provided by the electric generator between electrode 6 and electrode 3 supported by the reactor is distributed naturally between each of the electrodes Eₓ.

The “floating potential” is balanced in natural manner in the electrolyte bath flowing between the electrodes. This potential depends on the potential difference applied between the vessel and the cover of the reactor, and also on the number of electrodes Eₓ.

Preferentially, as represented in FIGS. 1 and 2, the additional electrodes Eₓ are bipolar. What is meant by bipolar is that the electrodes Eₓ can act both as anode and as cathode. A bipolar electrode presents two surfaces—an anodic surface 9 and a cathodic surface 10.

During the electrodeposition step, the metal is deposited on the cathodic surface and the native oxygen is formed on the anodic surface.

These particular electrodes are advantageously designed from materials suitable for the electrochemical conditions, and in particular for bipolarity. The electrodes are for example made from lead, tin, nickel, or titanium, with advantageously for each of said materials electrically conductive coatings such as non-oxide ceramics. These ceramics are advantageously non oxides, and can be formed by silicon carbide (SiC), titanium carbide (TiC), silicon nitride (Si₃N₄), titanium nitride (TiN), etc.

The electrodes can also be mixed bipolar electrodes made from lead oxide, combined tin and lead oxide, or from lead alloy.

Advantageously, the anodic surface 9 and cathodic surface 10 are made from different materials.

The cathodic surface is for example made from lead, lead oxide or stainless steel which may be coated or not.

Preferentially, electric power storage is performed on mixed bipolar electrodes made from tin and lead oxide and lead oxide.

The anodic surface preferentially comprises at least one metal wire wound to form a conical spiral. The metal wire is preferentially made from lead. According to another embodiment, the anodic surface is covered by a second metal wire wound to form a conical spiral, the second metal wire being made from tin.

Even more preferentially, the anodic surface comprises a set of metal wires, for example a cable composed by a number k of strands wound to form one or more conical spirals. This is referred to for example as a “Pappus” conical spiral. This configuration leads to a large increase of the specific exchange surface by a coefficient equivalent to π (3.14)×k resulting in retention of the native oxide. Advantageously there is no main gas release when the electrochemical reactions take place.

The twisted bundle of metal wires can present a cylindrical cross-section, as represented in FIG. 2, or it can present a star-shaped or cross-shaped cross-section.

Advantageously, the cross-section is a cylindrical cross-section.

Preferentially, the wound metal bundle is composed of a mixture of wires made from pure lead or with tin wires enclosing an oxide paste of said metals. This assembly of oxides and twisted wires composing the spiral can also be covered by a shield. The shield is for example a membrane porous to the electrolyte cut to fit the conical shape of the electrode. A polyethylene membrane can be used. Alternatively, the cable can be replaced by a braid. The braid has to be produced in such a way as to allow percolation of the electrolyte between each wire. The securing of the wires of the braid can be adjusted with support shims providing a slight clearance between each wire.

Preferentially, the angle b represented in FIG. 2, defined by the axis AA′ and the apothem L of the cone, is greater than 45°. Even more preferentially, the angle b is greater than 50° to prevent the oxides from detaching from the electrode by gravity effect.

Advantageously, the turns of the spiral or spirals are joined so as to cover the anodic surface 9 and so as to increase the quantity of active material on each electrode. If necessary, several layers of cables wound into a Pappus spiral can be stacked on one another to increase the exchange surface even further. Advantageously, the strands of the cables are assembled at their ends by soldering to one another and to the undercoat forming their support on the anode.

Preferentially, the anodic surface 9 of the additional electrodes Ex is covered by a coating of lead or lead alloy and the lead coating is covered by said spiral. The lead coating can be a sheet of lead foil. A sheet of tin foil can be used to replace the lead foil.

The surface S of each additional electrode Eₓ of conical shape is defined by:

S=πL.(R+r)

with:

L the apothem of the cone,

R the external radius of the cone,

r the internal radius of the cone,

L being able to be defined by L=r/sin b, with b the angle at the apex of the cone, the following is obtained: S=π(r/sin b).(R+r).

For R=0.85 m, r=0.05 m and sin b=0.766, the surface of the electrode is 2.97 m².

This specific configuration of a stack of additional electrodes of conical or frustum shapes, in a cylindrical volume, forms a very large exchange surface in a very small volume.

This exchange surface is further increased with the particular configuration of the anodic surfaces of the electrodes, i.e. with the metal wires wound to form a conical spiral.

The bipolar electrodes enable total reversal of polarity and of operation as counter-electrodes in the chemical attack phase when the polarities are reversed and the reactor is used as an electricity generator. In the electricity production phase, a chemical attack phase is performed on the metal deposited on the cathodic surfaces and an electric current is generated (battery effect).

For example, for 51 bipolar additional electrodes of conical shapes (electrodes in the form of a frustum for the odd additional electrodes Eₓ and electrodes in the form of a full cone for the even additional electrodes Eₓ), with a surface of about 3 m² in a reactor vessel with a height H of 1.5 m, the power P provided is P=E.I.

With E=53 pairs×2.85V≈150V and I=400 A/m²×3 m²=1200 A, the power is about 180 kW.

Advantageously, the set of bipolar additional electrodes Eₓ therefore forms a compact stack of electrochemical surfaces facing one another, one surface of which acts as anode and the other surface of which acts as cathode.

During operation of the electrochemical device, the electrolyte flows in a first phase between the first electrode 4 and the anodic surface of electrode E₁ until it reaches the side wall 2. Then it flows up along the additional electrode E₂, between the cathodic surface of electrode E₁ and the anodic surface of electrode E₂. At the apex of electrode E₂, it passes through the opening positioned at the top of said electrode and flows between the cathodic surface of electrode E₂ and the anodic surface of electrode E₃ until it reaches the side wall 2, and so on until it reaches the bottom of the reactor.

The association of bipolar electrodes with a stack of conical type ensures an ideal distribution of the electric currents flowing from a bipolar electrode to another electrode while at the same time ensuring a precise and controlled gravitational flow of the electrolyte fluxes of the chemical solution containing the metal to be deposited.

The additional electrodes Eₓ advantageously have the same surface.

The active reaction surface remains homogenous from one pair to the other, from the top of the reactor to the outside of the bottom, and a current iso-density is obtained.

The stack of additional electrodes Eₓ, of identical active surface, enables a perfect control of the surface of the pairs of electrodes to be obtained, which is thus constant.

This electrode assembly enables large reaction surfaces to be obtained in extremely small dimensions. The volume of the reactor 1 can be considerably reduced.

Such devices enable larger quantities of electric power to be stored than a device with flat electrodes, for the same reactor volume.

According to a preferential embodiment, the side wall 2 of the reactor is electrically insulating so as to prevent electric contact between the first electrode 4 and second electrode 6.

The electrically insulating side wall 2 ensures electric insulation not only of the electrodes Eₓ from one another, but also from the first electrode 4 and second electrode 6.

Advantageously, the side wall 2 of the reactor also acts as mechanical support for the electrodes. The position of the electrodes can be equalized by means of shims placed in the side wall 2 of the reactor.

The shims are advantageously made from electrically insulating material.

The electric insulation of the electrodes Eₓ inside the reactor is performed for example by the support of an electrically insulating ring, salient from the outside body of the reactor.

This configuration is particularly used when the reactor 1 comprises lead electrodes, in the case of direct electricity storage, without any gas release (reactor working at atmospheric pressure).

Preferentially, the shims are configured so that the cones forming the electrodes Eₓ, top wall 3 and bottom wall 5 are substantially parallel to one another.

In preferential manner, the distance between two consecutive electrodes Eₓ is substantially the same at any point along any axis parallel to the axis AA′. The potentials and chemical reactions are thus better distributed.

Preferentially, the distance between the electrodes is comprised between 0.5 cm and 1.5 cm, enabling ohmic losses to be considerably reduced.

The reversible electric power storage method comprises the following successive steps:
providing an electrochemical device as described in the foregoing,
performing inlet of an electrolyte to the electrochemical device, the electrolyte containing metal ions,
electrically connecting the first electrode to the negative terminal of an electric power supply and the second electrode to the positive terminal of an electric power supply,
providing electric power to reduce the metal ions on the electrodes so as to form a metal battery.

The electrolyte contains metal ions, which can be zinc, manganese or nickel ions, or they can be cadmium ions.

Preferentially, the electrolyte is a sulphate-base aqueous solution.

The sulphates are metal sulphates, advantageously chosen from lead, zinc, manganese or cadmium.

The first electrochemical step, i.e. energy storage, is performed by electro-deposition of the metal in solution on the electrodes of the electrochemical device.

In a first step, the metal ions in solution are reduced, and the metal deposits on the cathodes of the bipolar electrodes.

During the electrodeposition phase of the metal on the cathodes, i.e. on the reactor wall and on the cathodic surfaces of the bipolar electrodes nested in one another, oxygen is released at the anodes.

The oxygen transforms the metal phase of the anodic surface of the bipolar electrodes into oxide.

Electrodeposition is performed using the electric energy.

Electric power storage is performed in the form of a metal deposit.

When electrodeposition of the metal takes place, the metal content of the electrolyte is modified, decreasing progressively. Water containing sulphates of a metal can if necessary be continuously added to the electrolyte, which is also called liquor.

After formation of the electrolyzable metal battery, the method comprises an operating phase of said battery, the operating phase comprising dissolution of the previously deposited metal so as to produce electric power.

As the chemical attack of the metal progressively takes place, the metal is again placed in solution in the electrolyte. Dissolution of the metal produces a recombination of the hydrogen in water by simultaneous reduction of the oxides on the anode side.

The reactor has become an electric generator by battery effect. On account of the large exchange surface, its internal resistance is reduced.

The electric power is recovered by connecting the first electrode 4 and second electrode 6 to an electric power recovery system.

Preferentially, the device comprises an electrolyte tank connected to the electrolyte inlet 4 and to the electrolyte outlet 8 of the reactor 1 so as to form a closed circuit. The electrolyte, used to form the electrolyzable metal battery, is reused for the operating phase of said battery.

During the electrodeposition phase, the electrolyte is progressively stored in the storage tank. The tank then acts as supply reserve for the electric power production phase.

After the electrodeposition phase, i.e. after formation of the battery, the electrolyte is advantageously drained from the reactor 1. This draining of the electrolyte means that there is no longer any possible current flow and the circuit is open. This operation enables any electric self-discharge of said battery to be obviated during periods of non-use of the stored energy.

The metal deposition performed is stable when the electrolyte is drained from the tank and is no longer in contact with said deposited metal. The deposition is preserved for a very long time without oxidizing, intrinsically conserving the electric power it consumed during its electrodeposition.

Advantageously, the electrolyte is always drained with the equipment powered off. This operation, which is made very easy by the configuration of the reactor, prevents well-known problems of self-discharge of electric storage batteries.

The side wall comprises a draining device, advantageously located in the bottom part of the reactor. It is also possible to use a double side wall, the inner wall of the two being provided with check valves at the base of each electrode Eₓ to achieve more efficient draining.

The electrolyte, used to form the electrolyzable metal battery, is reused for the operating phase of said battery.

The electrolyte, formed in the previous operation, when operation as a battery takes place will again flow in a closed loop. The initial acid content, during this dissolution step, is high and the metal content is low. When dissolution takes place, the metal is placed in solution again.

For example, in the case of lead, during the production of electric power, the lead sulphate solution is regenerated for future reuse.

Depending on the configuration chosen, controlled flow of the electrolyte enables either direct storage of electric power or direct production of electric power in the form of electricity.

Several reactors can be electrically connected in series or in parallel.

Preferentially, the device comprises at least a second reactor, the two reactors being mounted in series, the two reactors being electrically connected.

The two reactors are in fluidic communication: the second reactor is located between the first reactor and the electrolyte tank, the electrolyte outlet of the first reactor being connected to the electrolyte inlet of the second reactor, and the electrolyte outlet of the second reactor being connected to the electrolyte tank.

The second reactor also comprises a plurality of electrodes. The second reactor is advantageously identical to the first reactor.

Advantageously, the electric connections for operation of the electrochemical device are very simple to make.

The reactor is supplied by a DC generator, during the energy storage phase, and the reactor itself behaves as a controlled generator during the metal dissolution phase.

The first electrode is connected to the negative terminal of the generator, whereas the second electrode, forming the anode, is connected to the positive terminal of the generator during the metal electrodeposition phase.

When the chemical attack takes place, the reactor acts as an electric power generator. It is then electrically connected to one or more electric power recovery systems.

An external DC power supply provides the external power necessary for electrodeposition and the connections enabling the directions of the electric currents to be reversed.

The very compact device presents a high active surface density in a small volume. The device advantageously operating at selected temperatures, close to ambient temperature, presents greatly improved heat exchange coefficients and enables partial and direct recovery of the electric power induced in the chemical dissolution reactions.

The method enables available electric power to be stored, for example during off-peak hours, and the stored electric power to be recovered with a high efficiency, for example during peak hours.

1-22. (canceled)

23. Electrochemical device for storing electric power comprising:
a reactor provided with:
a side wall,
a top wall,
a bottom wall,
an electrolyte inlet,
an electrolyte outlet,
a plurality of electrodes Eₓ with x an integer between 1 and n, located in the reactor, the plurality of electrodes Eₓ being either in the form of cone electrodes and frusta electrodes, the plurality of electrodes Eₓ being fitted in such a way that a tapered part of each electrode is directed towards the top wall or the bottom wall of the reactor, the frusta electrodes coming into contact with the side wall of the reactor, apexes of the cone electrodes defining an axis passing through open areas of the frusta electrodes, the cone electrodes and the frusta electrodes being arranged alternately.

24. Electrochemical device according to claim 23, wherein the plurality of electrodes Ex are provided with an anodic surface and a cathodic surface, the anodic surface and cathodic surface being made from different materials.

25. Electrochemical device according to claim 24, wherein the anodic surface is covered by at least one metal wire wound to form a conical spiral.

26. Electrochemical device according to claim 25, wherein turns of the conical spiral are joined so as to cover the anodic surface.

27. Electrochemical device according to claim 25, wherein the at least one metal wire is made from lead.

28. Electrochemical device according to claim 27, wherein the anodic surface is covered by a second metal wire wound to form a conical spiral, the second metal wire being made from tin.

29. Electrochemical device according to claim 23, wherein the plurality of electrodes Ex have the same surface.

30. Electrochemical device according to claim 23, wherein the top wall and bottom wall are of conical shape.

31. Electrochemical device according to claim 30, wherein the cones forming the plurality of electrodes Eₓ, the top wall and bottom wall are substantially parallel to one another.

32. Electrochemical device according to claim 23, wherein:
the electrolyte inlet is located in the top wall,
the electrolyte outlet is located in the bottom part of the reactor, between the bottom wall of the reactor and electrode Eₙ,
the plurality of electrodes Eₓ with x an odd integer are cone electrodes separated from the side wall of the reactor by a space,
the plurality of electrodes Eₓ with x an even integer are frusta electrodes in contact with the side wall of the reactor and the frusta electrodes are provided with an opening at an apex of the cone,
so as to form a flow path of the electrolyte, the flow path going from the electrolyte inlet to the electrolyte outlet, passing alternately between the electrodes Eₓ with x an odd integer and the side wall of the reactor and in the openings arranged in frusta electrodes.

33. Electrochemical device according to claim 23, wherein the plurality of electrodes Eₓ are electrically insulated from one another.

34. Electrochemical device according to claim 23, wherein the top wall forms a cathode or the bottom wall forms an anode.

35. Electrochemical device according to claim 23, comprising an electrolyte tank connected to the electrolyte inlet and to the electrolyte outlet of the reactor so as to form a closed circuit.

36. Electrochemical device according to the claim 35, including at least a second reactor comprising a plurality of electrodes, the two reactors being mounted in series, the two reactors being electrically connected, and wherein second reactor is located between the first reactor and the electrolyte tank, the electrolyte outlet of the first reactor being connected to an electrolyte inlet of the second reactor, and an electrolyte outlet of the second reactor being connected to the electrolyte tank.

37. Electrochemical device according to claim 23, wherein a first electrode of the plurality of electrodes Eₓ is electrically connected to a negative terminal of an electric power supply and wherein a second electrode of the plurality of electrodes Eₓ is connected to a positive terminal of the electric power supply.

38. Electrochemical device according to claim 23 wherein a first electrode of the plurality of electrodes Eₓ and a second electrode of the plurality of electrodes Eₓ are connected to an electric power recovery system.

39. Method for storing electric power, comprising the following successive steps:
providing an electrochemical device according to claim 23,
performing inlet of an electrolyte to the electrochemical device, the electrolyte containing metal ions,
electrically connecting the first electrode to a negative terminal of an electric power supply and the second electrode to a positive terminal of an electric power supply,
providing electric power to reduce the metal ions on the plurality electrodes of the electrochemical device so as to deposit metal and form an electrolyzable metal battery.

40. Method according to claim 39, comprising, after formation of the electrolyzable metal battery, an operating phase of said electrolyzable metal battery, the operating phase comprising dissolution of the deposited metal so as to produce electric power.

41. Method according to claim 40, wherein, when dissolution of the deposited metal takes place, the first electrode and second electrode are connected to an electric power recovery system.

42. Method according to claim 40, wherein the electrolyte, used to form the electrolyzable metal battery, is reused for the operating phase of said battery.

43. Method according to claim 39, wherein, after forming the electrolyzable metal battery, the electrolyte is drained from the reactor.
